(19) United States
(12) Patent Application Publication
(10) Pub. No.: US 2008/0315039 A1
(43) Pub. Date: Dec. 25, 2008

(54) System and methods for space vehicle torque balancing

(76) Inventors: Lael Rudd, Redondo Beach, CA (US); Bernard Morgowicz, Manhattan Beach, CA (US)

Correspondence Address: PATTI, HEWITT & AREZINA LLC, ONE NORTH LASALLE STREET, 44TH FLOOR, CHICAGO, IL, 60602, US

(21) Appl. No.: 11/820,916

(22) Filed: Jun. 21, 2007

(51) Int. Cl. B64G 1/24

(52) U.S. Cl. 244/164

(57) ABSTRACT

A spacecraft attitude controller balances external torques, including those resulting from gravity gradient and those resulting from other orbital disturbances, to achieve a comparatively stable, neutral attitude or orientation. Torque is balanced by selecting spacecraft attitude Euler angles and angular rates such that orbital disturbances and cross-coupling inertial effects are cancelled by the external forces, based on Euler's equation. A spacecraft attitude torque-balancing controller and related method compares spacecraft attitude angles and angular rates with an orbit reference frame, and provides instructions to conventional momentum management and propulsion controls to responsively adjust the spacecraft attitude and angular rates. This feedback loop drives to zero (or an acceptably small quantity) the rate of change of the difference between spacecraft and reference attitude and angular rates, thus minimizing the net accelerations on the vehicle. A further method is provided to determine a desired physical structure and mass distribution of the spacecraft, needed to achieve torque balancing in a spacecraft attitude such that appliances, such as antennas, solar panels, and instruments, will have the required orientation once in their final on-orbit deployed position.

### TECHNICAL FIELD

This invention relates generally to control of space vehicles, and more particularly to systems and methods for controlling the orientation of space vehicles, including satellites on orbit, which are subject to a variety of external torques.

### BACKGROUND

Controlling the orientation of space vehicles is a significant challenge for both the engineers who design them and those who control the vehicles throughout their missions. Spacecraft launched from Earth generally rely on combustion-type rocket engines, at least in part, to move the spacecraft into a desired location and orientation. The thrust from the rocket engine may or may not be directly steerable. Most spacecraft also have one or more additional propulsive devices to enable control of the spacecraft's location and orientation, and the rates of change associated with location and orientation. For example, a number of technologies have been applied to control spacecraft location and orientation, including small combustion-based engines, means other than combustion to expel a gas, means to emit a stream of ions, and means which control the internal momentum of the spacecraft. Each of these devices may impart forces and torques on the vehicle. Aside from gross positioning, it is often desirable to control a spacecraft's orientation or attitude, within predefined error boundaries, in order that appliances, such as solar panels, antennas, cameras, sensors, instruments, and other devices be correctly oriented.

Spacecraft are subject to a number of phenomena that impart forces or torques on the vehicle. These include, but are not limited to: atmospheric and aerodynamic effects; solar electromagnetic radiation; solar wind; magnetic effects; the effects of thermal and electromagnetic radiation by the vehicle; intentional venting from the spacecraft; leaks; and gravitational effects, including gravity gradient. Any of these can disturb the position and orientation of the spacecraft.

Gravity gradient refers to the variation in gravitational attraction experienced by portions of the spacecraft located at different distances from Earth (or another body). Gravity gradient torques are inversely proportional to the cube of the distance from Earth and other large bodies. Because gravitational attraction on portions of the spacecraft closer to Earth is greater than gravitational attraction on portions of the spacecraft further from Earth, the spacecraft will experience a torque due to gravity gradient unless the spacecraft is already aligned such that the minimum axis of inertia is either perpendicular (unstable orientation) or aligned with (stable orientation) the radial direction towards the center of the Earth.

Magnetic and aerodynamic effects also diminish with distance from Earth; as distance increases, these effects become negligible, and at sufficiently large distance from the Earth the principal disturbances arise from solar radiation and solar wind. The disturbances may vary over time in both amplitude and direction. For example, a spacecraft in Earth orbit may experience solar radiation and solar wind in varying amplitudes over time, as the craft passes through the shadow of the Earth. In addition, due to its orbital motion the direction of the solar effects also varies over time with respect to the spacecraft's frame of reference. In many cases the disturbances vary cyclically.

Spacecraft have limited capacity for storage of propellants, other fuels, and electrical energy, and they have limited ability to collect and transform energy into useful forms following the spacecraft's launch. Some spacecraft are able to develop considerable amounts of electricity using solar panels or nuclear power generators. However, propellants are in limited supply, and once they are used, they generally cannot be recovered or replenished. The continual use of propellants to adjust spacecraft orientation responsive to disturbing torques tends to deplete the available supplies, particularly if the disturbing torques are secular so that the spacecraft orientation continually diverges from the desired attitude unless corrected by some on-board means.

Many spacecraft are equipped with momentum exchange devices that employ conservation of angular momentum to produce torques needed to adjust spacecraft orientation, even in the presence of external disturbance torques, without the continual use of propellants. Several different types of momentum exchange devices have been constructed, including “reaction wheels” and “control moment gyroscopes”. These devices generally employ one or more rotating masses, or “wheels”. When the spacecraft experiences an external torque, a restorative torque may be generated by the momentum exchange device by increasing or decreasing the rotational speed of the wheel or changing the orientation of the wheel with respect to the spacecraft. When these devices are initialized, it is typically necessary to use propulsive devices to oppose the torque produced by accelerating the wheel. For each axis for which a momentum exchange device is equipped, if the disturbance torques are secular and are predominantly experienced in one direction (sign), the momentum exchange device will accumulate more and more momentum. This means that the rotational speed of the wheel will continue to increase until predefined limits are reached. Once the maximum rotational speed is reached, additional momentum cannot be absorbed, and the momentum exchange device is said to be “saturated”. In that case, it is necessary to reduce or “dump” momentum from the momentum exchange system by reducing the speed of the wheel while using propulsive devices to oppose the torque produced by decelerating the wheel.

Using momentum exchange devices can provide a significant advantage over propellant-based positioning alone, particularly when the disturbance torques are cyclical. Within the devices' operational limits, the acquisition or release of angular momentum responsive to an external torque is generally reversible when the external torque changes sign. Thus, if cyclical torques are of small enough magnitude that the momentum exchange devices are not saturated, the spacecraft's orientation may be controlled with relative stability, through several or many cycles, without using propulsive devices.

Although momentum exchange devices can help minimize use of propulsive devices, and the consequent depletion of fuels, propellants, or other consumables, when a spacecraft experiences cyclical torques, momentum exchange devices have limited range before saturation, and their operation consumes energy.

Also, spacecraft may experience net secular torques in a predominant direction or sign, thereby causing accumulation of angular momentum which must be counteracted by the use of propulsive devices. In the case of interplanetary satellites, solar effects, such as solar radiation and solar wind, and for conventional satellites in Earth's orbit gravity gradient, are typical of torque-producing disturbance effects that may result in accumulation of momentum and may require consistent or frequent use of propulsive devices to maintain a desired spacecraft orientation or attitude. Although some have attempted to use gravity gradient as a primary or exclusive means of spacecraft attitude control, gravity gradient has not been successfully applied in that role because it has not provided sufficient positioning accuracy and stability for most spacecraft missions.

Thus, the need exists for systems and methods for controlling the orientation of spacecraft subject to external disturbance torques while minimizing use or propulsive devices and momentum exchange devices.

### SUMMARY

Systems and methods for controlling the attitude of a spacecraft using torque balancing mitigate or eliminate disadvantages of prior attitude control systems. According to an aspect of the invention, a spacecraft may balance external torques, including those resulting from gravity gradient and those resulting from other orbital disturbances, to achieve a comparatively stable, neutral attitude or orientation. Torque is balanced by selecting spacecraft attitude angles and angular rates with respect to the spacecraft orbit reference frame such that orbital disturbances and cross-coupling inertial effects are cancelled by the external forces.

According to a further aspect of the invention, a spacecraft attitude torque-balancing controller and related method compare spacecraft attitude angles and angular rates with an orbit reference frame, and provide instructions to conventional momentum management and propulsion controls to responsively adjust the spacecraft attitude. This feedback loop drives to zero (or an acceptably small quantity) the rate of change of the difference between spacecraft attitude and angular rate and the attitude and angular rate of the orbital reference frame. When the difference between these state parameters stops changing, the torque-balanced, neutral spacecraft attitude has been achieved. According to an aspect of the invention, a controller implements a strategy to adjust Euler angles (or analogous members of another mathematically-equivalent system of parameters) such that the vehicle experiences no or acceptably small rates and accelerations relative to the orbital reference frame.

According to a further aspect of the invention, a method is provided for determining certain design parameters for a spacecraft which is intended to use torque balancing to minimize or eliminate reliance on or use of conventional momentum management systems or propulsion systems. By carefully selecting the physical structure and mass distribution of the spacecraft, the spacecraft attitude required to achieve torque balancing can be selected such that appliances, such as antennas, solar panels, and instruments, will have the required orientation. At least in part, such design contemplates selecting the distribution of mass such that gravity gradient effects, in combination with other external torques and cross-coupling inertial effects, produce the desired spacecraft attitude.

The spacecraft torque balancing systems and methods described herein can be used advantageously to maintain a spacecraft in a desired orientation, within given error bounds. When used in combination with a conventional momentum management system, the torque balancing system described can significantly alleviate the load placed on the conventional momentum management system. In addition, the torque balancing described above may greatly reduce the need to operate propulsion devices, and could render a conventional momentum management system unnecessary. This can advantageously extend the life of a spacecraft, by allowing limited supplies of consumable propellants or fuels needed for periodic momentum unloading to last longer, or to allow a spacecraft to continue to function after it has exhausted its supply of consumable propellants or fuels or if its conventional momentum management system has failed.

### DESCRIPTION OF THE DRAWINGS

Features of example implementations of the invention will become apparent from the description, the claims, and the accompanying drawings in which:

FIG. 1a is a side view of an example embodiment 100 of a spacecraft constructed according to an aspect of the present invention in orbit about a body such as Earth;

FIG. 1b is a schematic view depicting an orbital reference frame of the spacecraft 100 of FIG. 1;

FIG. 2 is a flow diagram showing the steps of an example method 200 for use in conjunction with the spacecraft 100 of the present invention for determining design parameters of the spacecraft;

FIG. 3 is block diagram of an example control system 300 for use in conjunction with the spacecraft 100 of the present invention for controlling spacecraft orientation; and

FIG. 4 is a flow diagram showing the steps of an example method 400 for use in conjunction with the spacecraft 100 of the present invention for controlling orientation of the spacecraft, whereby orbital disturbances and cross-coupling inertial effects are balanced by external torques.

### DETAILED DESCRIPTION

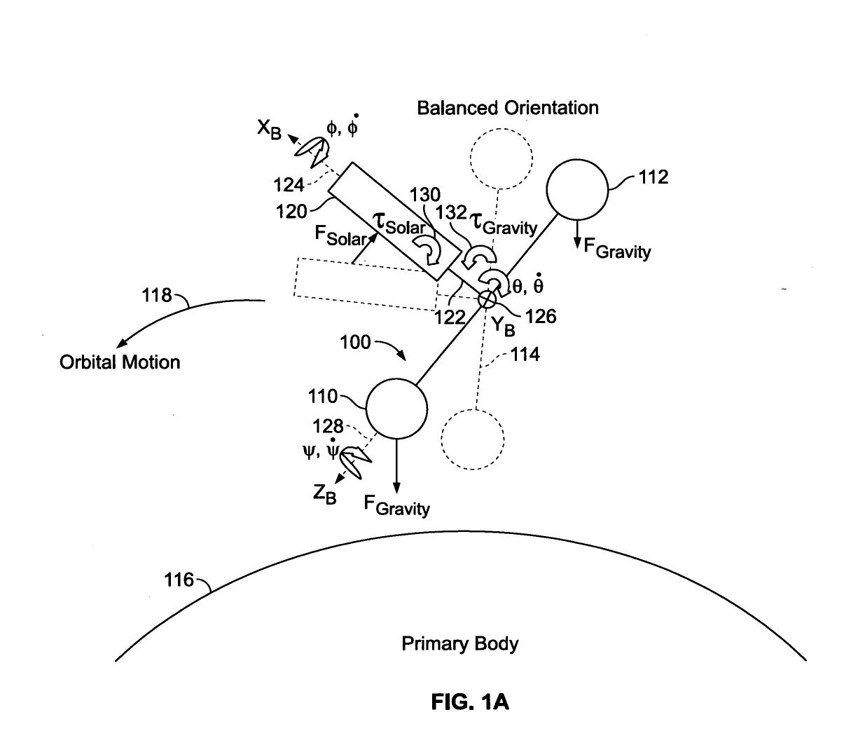

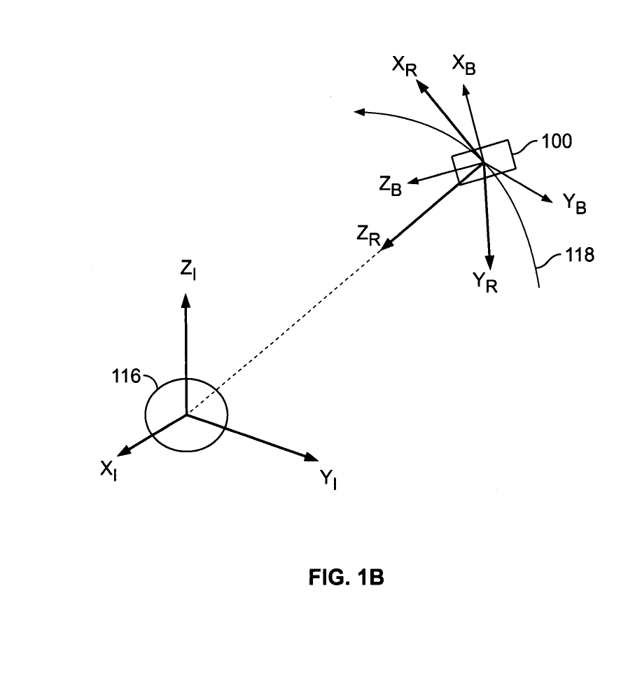

FIG. 1 is a side view of an example embodiment 100 of a spacecraft constructed according to an aspect of the present invention. The spacecraft 100 is shown along an orbital path 118 around a primary body 116 such as Earth. The drawing is not to scale, and the curvature of the primary body 116 and the orbital path 118 are greatly exaggerated.

The spacecraft 100 is described herein in the application environment of an orbiting satellite, by way of example but not limitation, to show how challenges encountered in this environment may be mitigated or overcome according to an aspect of the invention. However, one of skill in the art will appreciate that the invention could also be advantageously applied to many other spacecraft, in environments not limited to orbital satellites, without modification or with modifications within the ken of a person of skill in the art, consistent with the spirit of the invention.

The present application relates at least in part to control systems, which may be implemented using a variety of electronic and optical technologies, including but not limited to: analog electronic systems; digital electronic systems; microprocessors and other processing elements; and software and otherwise embodied collections of steps, instructions, and the like, for implementing methods, processes, or policies in conjunction with such systems and processing elements. It will be appreciated that in the control system arts, various signal leads, busses, data paths, data structures, channels, buffers, message-passing interfaces, and other communications paths may be used to implement a facility, structure, or method for conveying information or signals, and are often functionally equivalent. Accordingly, unless otherwise noted, references to apparatus or data structures for conveying a signal or information are intended to refer generally to all functionally equivalent apparatus and data structures.

Spacecraft 100 is depicted in an exemplary configuration in the form of a stylized “dumbbell” having first and second similar masses 110 and 112 separated by a thin structural member of negligible mass. The simple shape and particular structural characteristics described for spacecraft 100 is a traditional configuration used to analyze spacecraft dynamics and is presented here to depict the principles of an aspect of the present invention. Different structures, shapes, and mass distributions could, and would likely, be used in a practical embodiment of a spacecraft. If gravity gradient were the only external force/torque operating on the spacecraft 100, a torque 132 produced by the gravity gradient would tend to rotate the spacecraft 100 into the nominally balanced position shown by dotted shape 114, in which the spacecraft is oriented such that the minimum axis of inertia is aligned with radial direction towards the gravitational center of the primary body 116.

A roll axis with respect to spacecraft 100 is identified as 124; the Euler angle of the spacecraft 100 with respect to the roll axis 124 is referred to as ø. A pitch axis is identified as 126; the Euler angle of the spacecraft 100 with respect to the pitch axis 126 is referred to as θ. A yaw axis is identified as 128; the Euler angle of the spacecraft 100 with respect to the yaw axis 128 is referred to as ψ. Spacecraft 100 may have a solar collector panel 120 attached to the spacecraft by solar panel connecting member 122. A torque arising from solar wind or solar radiation is shown by arrow 130. The depiction of torques 130 and 132 as single arrows is a simplification, in each case representing the net torque arising from the noted source.

Although spacecraft attitude is described herein in terms of Euler angles, one of skill in the art will appreciate that the present invention does not rely on specifying spacecraft attitude using those particular parameters. Spacecraft attitude may be equivalently specified using any suitable parameters including quaternions, Euler parameters, Rodriquez parameters, and the like, without departing from the spirit of the invention.

FIG. 1b is a schematic view depicting an orbital reference frame of the spacecraft 100 of FIG. 1. A first set of orthogonal coordinate axes X_{I}, Y_{I}, Z_{I} are defined with respect to the primary body 116. A second set of orthogonal coordinate axes X_{B}, Y_{B}, Z_{B} are defined with respect to the spacecraft body 100. A third set of orthogonal coordinate axes X_{R}, Y_{R}, Z_{R} define the orbit reference frame. The Z_{R} axis points toward the center of mass of the primary body 116. The X_{R} axis is in the plane of the orbit, in the direction of the velocity of the spacecraft perpendicular to the Z_{R} axis. Velocity and X_{R} may not be coincident. In the most general case, Z_{R} and velocity define a plane from which Y_{R} is perpendicularly defined; the true X_{R} is defined from another cross-product operation. The Y_{R} axis is normal to the local plane and completes the three-axis right-hand orthogonal system.

According to an aspect of the present invention, spacecraft 100 preferably balances all external torques on the vehicle arising from orbital disturbances and other effects, and all internal torques including cross-coupling inertial effects. This is depicted schematically in FIG. 1a, in which spacecraft 100 is shown in an orientation skewed about the pitch axis 126 and with appropriate angular rates. In this orientation, the torque 132 produced by the gravity gradient balances torque 130 produced by solar wind or radiation, along with other torques arising from other orbital disturbances, and along with any inertial cross-coupling terms. Therefore, although the spacecraft orientation appears skewed and may possess angular rates 5 along all three spacecraft body axes, the spacecraft is actually in the neutral or stable attitude which minimizes the need for intervention by the conventional momentum control system or propulsion system.

In order to achieve this balancing, Euler's equation of motion for a rigid body:

\vec{T}={right arrow over (\dot{h}_{I}={right arrow over (\dot{h}+\vec{ω}×\vec{h}

is solved for a set of three attitude angles and three angular rates for the spacecraft 100 so that the torques induced by an orbital rate about the body (e.g. Earth 116) and the cross product of inertia terms balance the external torques on the spacecraft. (T is torque; h is angular momentum; and ω is angular rate). An expansion of Euler's equation:

ΣTₓ(ø, θ, ψ)=Iₓₓ\dot{ω}ₓ+I_{xy}(\dot{ω}_{y}−ωₓω_{y})+I_{xz}(\dot{ω}_{z}+ωₓω_{y})+(I_{zz}−I_{yy})ω_{y}ω_{z}+I_{yz}(ω_{y}²−ω_{z}²)

ΣT_{y}(ø, θ, ψ)=I_{yy}\dot{ω}_{y}+I_{xy}(\dot{ω}ₓ+ω_{y}ω_{z})+I_{yz}(\dot{ω}_{z}−ωₓω_{y})+(Iₓₓ−I_{zz})ωₓω_{z}+I_{xz}(ω_{z}²−ωₓ²)

ΣT_{z}(ø, θ, ψ)=I_{zz}\dot{ω}_{z}+I_{xz}(\dot{ω}ₓ−ω_{y}ω_{z})+I_{yz}(\dot{ω}_{y}+ωₓω_{z})+(I_{yy}−Iₓₓ)ωₓω_{y}+I_{xy}(ωₓ²−ω_{y}²)

shows that there are six variables ø, θ, 104 , ωx, 107 y, and ωz that can be manipulated to balance the equation. (ø is the Euler angle about the x, or roll axis; θ is the Euler angle about the y or pitch axis; ψ is the Euler angle about the z or yaw axis; and ωx, ωy, and ωz are the angular rates about the x-, y, and z-axes, respectively.) The result of the balancing is that there is no change in angle between the spacecraft 100 and the orbit reference frame. Thus, the goal is to calculate the combination of the six variables that make the angular acceleration of the spacecraft relative to the orbit reference frame zero:

{right arrow over (\dot{ω}=I⁻¹(Σ\vec{T}(ø, θ, ψ)−\vec{ψ}×\vec{h})=0

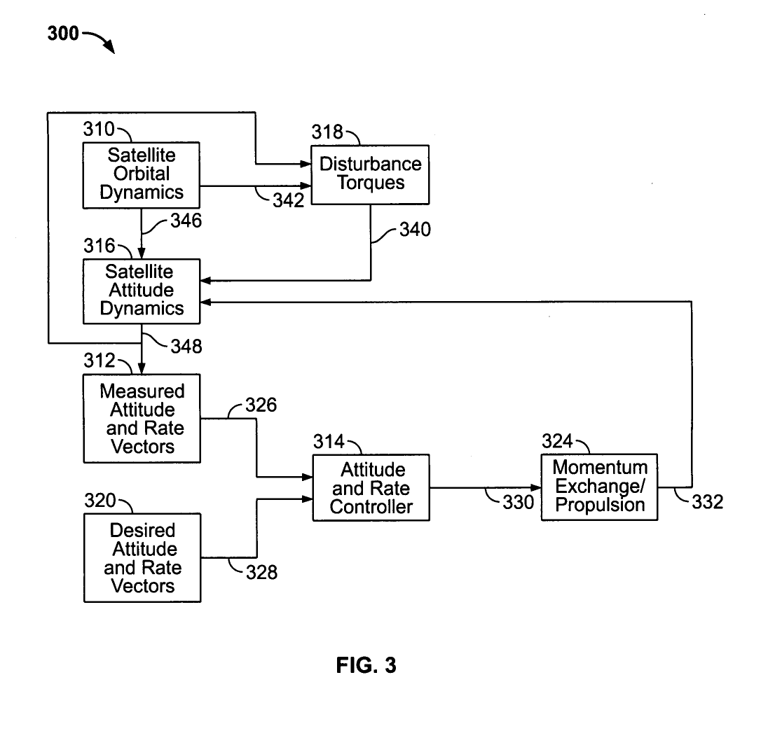

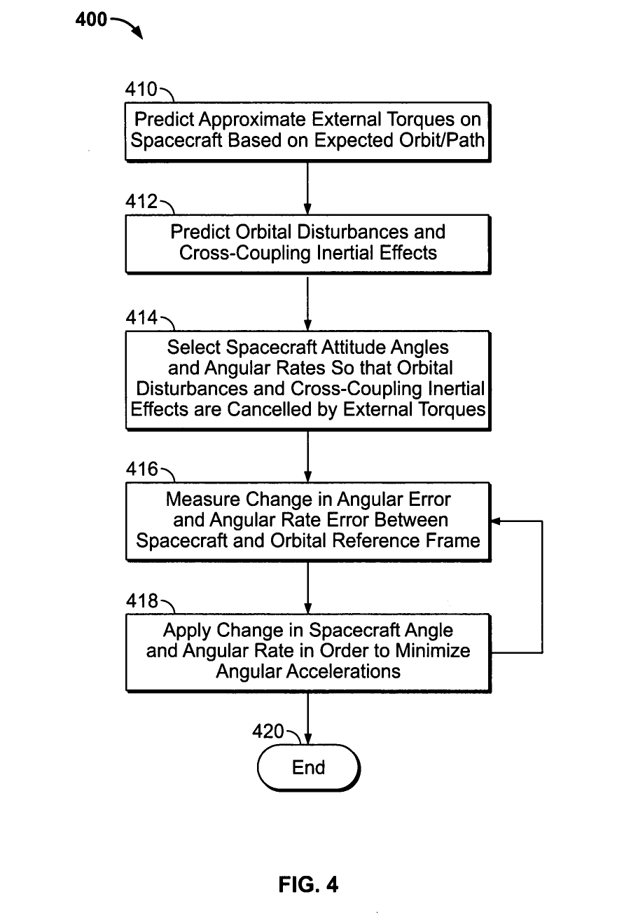

The balancing of torques described above can be physically realized by using feedback control to drive the body-to-reference-frame angular rate errors and angular position errors to zero. A controller for the spacecraft implementing this control strategy is discussed further in connection with FIG. 3, and a method which may be implemented by the controller is discussed further in connection with FIG. 4.

The spacecraft torque balancing described above can be used advantageously to maintain a spacecraft in a desired orientation, within given error bounds. When used in combination with a conventional momentum management system, the torque balancing described above can significantly alleviate the load placed on the system. In addition, the torque balancing described above may greatly reduce the need to operate propulsion devices, and could render a conventional momentum management system unnecessary. This can advantageously extend the life of a spacecraft, by allowing limited supplies of consumable propellants or fuels needed for periodic momentum unloading to last longer, or to allow a spacecraft to continue to function after it has exhausted its supply of consumable propellants or fuels or if its conventional momentum management system has failed.

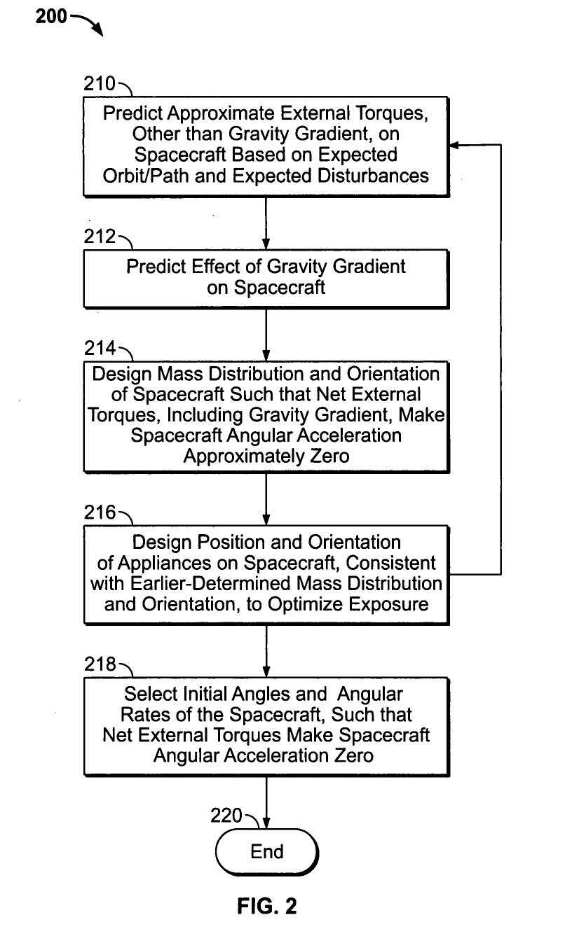

According to a further aspect of the present invention, as best seen in FIG. 2 there is provided a method 200 for determining certain design parameters for a spacecraft, such as spacecraft 100, which is intended to use torque balancing to minimize or eliminate reliance on or use of conventional momentum management systems or propulsion systems. Although it is possible to apply the torque balancing heretofore described to a spacecraft using a feedback-based controller as shown in FIG. 3, without specifically designing the physical structure and mass distribution of the spacecraft to optimize performance when the spacecraft is controlled by a torque-balancing controller, the resulting attitude of the spacecraft which may be required in order to balance the torques may not be a desired attitude with respect to the exposure and orientation of appliances, such as antennas, solar panels, cameras, sensors, instruments, and the like. By carefully selecting the physical structure and mass distribution of the spacecraft, the spacecraft attitude required to achieve torque balancing can be selected such that appliances will have the required orientation. At least in part, such design contemplates selecting the distribution of mass such that gravity gradient effects, in combination with other external torques and cross-coupling inertial effects, produce the desired spacecraft attitude.

As best seen in FIG. 2, method 200 commences with step 210, in which approximate external torques on the spacecraft, other than gravity gradient, are predicted. The prediction uses the known physical characteristics of the spacecraft, the expected orbit or path of the spacecraft, and any expected disturbances which may produce external torques. In step 212, the effect of gravity gradient on the spacecraft is predicted. In step 214, the mass distribution and orientation of the spacecraft is adjusted such that external torques, including that caused by gravity gradient, makes the spacecraft angular acceleration relative to its orbital reference frame approximately zero.

In step 216, the position and orientation of the appliances on the spacecraft are determined so as to optimize their exposure to meet mission requirements, consistent with the earlier-determined mass distribution and orientation. Because changes to the mass distribution and the orientation and location of appliances on the spacecraft may affect balancing of torques, it may be desirable to perform steps 210 through 216 iteratively. Thus, the method may return to step 210. Iteration may be terminated when the changes to the determined parameters between iterations diminish to an acceptably small value. Once iteration is complete, or if only one pass through steps 210-216 are deemed sufficient, the method continues at step 218. In step 218, initial Euler angles and angular rates for the spacecraft are selected such that net external torques make the spacecraft angular acceleration relative to the spacecraft orbital reference frame zero (or acceptably small).

FIG. 3 is block diagram of an example control system 300 for use in conjunction with the spacecraft 100 of the present invention for controlling spacecraft orientation. Control system 300 preferably includes a component 310 for determining the parameters of the spacecraft orbital dynamics expressed in terms of the orbit reference frame. The orbit reference frame describes the orbital movement and attitude of an ideal object which is not subject to external torques or disturbances. Orbital dynamics determination component 310 may model the orbit reference frame using orbital parameters measured onboard the spacecraft or may obtain these parameters from an external tracking function. Control system 300 preferably further includes a component 316 for determining spacecraft attitude dynamics in terms of the orbit reference frame. In a physical embodiment of a spacecraft employing the control system 300, spacecraft orbital dynamics and several possible disturbance torques, represented by box 318, influence spacecraft attitude dynamics; this influence is represented by paths 340 and 346. The disturbance torques represented by box 318 include external disturbance torques, including but not limited to solar, magnetic, and gravity gradient torques. Internal disturbance torques are presumed to be accounted for in spacecraft attitude dynamics component 316. The disturbance torques depend, in part, on the spacecraft orbital dynamics and spacecraft attitude dynamics, as indicated by paths 342 and 348.

Control system 300 preferably further includes a component 312 for determining the spacecraft attitude (the three Euler angles about roll, pitch, and yaw), and the corresponding angular rates relative to the orbit reference frame. The spacecraft attitude determination component 312 may similarly obtain orbital parameters sensed on-board the spacecraft, or may obtain these parameters from an external tracking function. Some information used in determining spacecraft attitude and angular rates may be obtained from the spacecraft attitude dynamics determination component 316 via path 348. Control system 300 preferably further includes a component 320 for establishing “desired” or target initial spacecraft attitude and angular rate parameters. Component 320 may be realized as part of a computer-based controller or an electronic or mechanical control such as a potentiometer or valve. These parameters may be initially defined as targets for orienting the spacecraft based on predicted orbital disturbances and other torques. Because these disturbances and torques may not be perfectly predicted, it is desirable to adjust these parameters to achieve a torque-balanced configuration. In the most general case, the magnitudes of the space disturbances are known to limited precision, but not exactly, before the spacecraft is deployed. Additionally, many space disturbances are time-varying phenomena. In such instances, the desired attitude and angular rate parameters are preferably adjusted either autonomously by the controller 300, or by ground controllers. If the desired attitude and angular rate parameters are autonomously adjusted by controller 300, that function may be performed by the target attitude and rate parameter establishing component 320, the spacecraft attitude dynamics determination component 316, or other components, in any combination.

Control system 300 preferably further includes a spacecraft attitude and rate controller 314. Controller 314 may be any appropriate spacecraft attitude and rate controller, including but not limited to a proportional-integral-differential (PID) controller. Controller designs which are suitable for realizing controller 314 are known in the art. Controller 314 preferably incorporates an element for comparing, or measuring the difference between, the measured attitude and rate vectors determined by component 312 and supplied via path 326 with the “desired” or target spacecraft attitude and rate vectors established by component 320 and supplied via path 328. Controller 314 uses this comparison or measured difference to develop appropriate control signals, supplied via path 330, to a momentum exchange/propulsion unit 324. When the rate of change of this difference is zero (or acceptably small), the spacecraft has successfully balanced cross-coupling inertial effects and external torques, including that produced by the gravity gradient, and has reached the desired neutral attitude.

Momentum management and propulsion unit 324 may be of conventional design, may employ any suitable technology to affect the position or attitude of the spacecraft, and may include any one or both of momentum exchange equipment and propulsion equipment. The attitude and rate controller 314 preferably furnishes information to the momentum management and propulsion unit 324 via signal path 330 to initially orient the spacecraft in or near the desired torque-balancing, neutral attitude.

Once the spacecraft is established in the target angular position and rates, such that the angular accelerations are minimized, less momentum build-up will occur, and less control activation is necessary to maintain the vehicle within certain angular bounds. Less propellant or less frequent momentum wheel unloading is required to maintain spacecraft attitude within these angular bounds. Under certain conditions, such as when the spacecraft has deviated from the preferred attitude, but information available to the controller 314 indicates that the deviation is transient and acceptable in magnitude and will likely be corrected by torque balancing without need for intervention by the conventional momentum management and propulsion unit 324, the controller 314 may inhibit or delay the operation of the momentum management and propulsion unit 324 that would ordinarily be used to correct spacecraft attitude. The information regarding whether any deviation in spacecraft attitude is acceptably small and will likely be corrected by torque balancing may be established in or furnished by orbital dynamics determining component 310 or the attitude dynamics determining component 316, and may be presented in the form of a threshold or similar signal, or a more complex control strategy.

This behavior, in effect, trades off precise spacecraft attitude control for a reduction in the energy or propellant expended by the momentum management and propulsion unit 324. Depending on the spacecraft mission and equipment, less precise attitude control may have no effect, or a tolerably small effect, on mission performance. The reduction in propellant or energy requirements can be quite valuable in extending the life of a spacecraft. In some cases, even a spacecraft without an operative momentum management or propulsion system, or with only partially-operative components, may remain useable because torque balancing may maintain the spacecraft in a sufficiently stable attitude close to the desired attitude. For example, if a reaction wheel actuator fails, the spacecraft can be maneuvered into the torque-balanced neutral orientation using thrusters, and may remain useful if the mission can tolerate some attitude variation and does not require a high degree of pointing accuracy.

The information flow between the desired spacecraft attitude and angular rate determination component 320 and the controller 314 may be carried via signal path 328. Thereafter, the controller uses feedback, measuring the rate of change of the difference between the orbit reference frame and the actual (measured) spacecraft attitude parameters, and driving that difference to zero, to converge on the actual torque-balancing, neutral attitude. An information path 332 is provided to show the feedback path between momentum management and propulsion unit 324 and spacecraft attitude determination component 316 as a closed loop; however, the actual feedback path is through the momentum management and propulsion systems which effect changes in actual physical spacecraft attitude, which are then measured or determined by spacecraft attitude determination component 316.

FIG. 4 is a flow diagram showing the steps of an example method 400 for use in conjunction with the spacecraft 100 of the present invention for controlling orientation of the spacecraft, whereby orbital disturbances and cross-coupling inertial effects are balanced by external torques. The steps of the method may be performed by a controller, such as controller 300 of the type shown in FIG. 3, or by another appropriate controller. In step 410, approximate external torques on the spacecraft are predicted, based on the spacecraft's expected orbit or path. In step 412, orbital disturbances and cross-coupling inertial effects on the satellite are predicted. In step 414, appropriate spacecraft attitude Euler angles and angular rates are determined, such that orbital disturbances and cross-coupling inertial effects are cancelled by the external torques. In step 416, the change in angular error and angular rate error between the spacecraft and the orbit reference frame is measured. In step 418, the rate of change in spacecraft angle and angular rate are used to adjust the spacecraft orientation such that spacecraft angular accelerations are minimized. This process may continue indefinitely by returning to step 416. If continued minimization of spacecraft angular accelerations (or changes in angular error and angular rate error between the spacecraft and the orbit reference frame) is not required, the method may terminate in step 420.

The steps or operations described herein are just for example. There may be many variations to these steps or operations without departing from the spirit of the invention. For instance, the steps may be performed in a differing order, or steps may be added, deleted, or modified.

Thus, there have been described systems and methods for controlling the attitude of a spacecraft using torque balancing. According to an aspect of the invention, a spacecraft may balance external torques, including those resulting from gravity gradient and those resulting from other orbital disturbances, to achieve a comparatively stable, neutral attitude or orientation. Torque is balanced by selecting spacecraft attitude Euler angles and angular rates such that orbital disturbances and cross-coupling inertial effects are cancelled by the external forces. Although spacecraft attitude is described herein in terms of Euler angles, the present invention does not rely on specifying spacecraft attitude using those particular parameters, and any suitable parameters including quaternions, Euler parameters, Rodriquez parameters, etc., could also be used. According to a further aspect of the invention, a spacecraft attitude torque-balancing controller and related method compares spacecraft attitude angles and angular rates with an orbit reference frame, and provides instructions to conventional momentum management and propulsion controls to responsively adjust the spacecraft attitude and rates. This feedback loop drives to zero (or an acceptably small quantity) the rate of change of the attitude error and attitude rate error relative to the orbit reference frame. When the difference between these state parameters stops changing, the torque-balanced, neutral spacecraft attitude has been achieved. According to a further aspect of the invention, a method is provided for determining certain design parameters for a spacecraft which is intended to use torque balancing to minimize or eliminate reliance on or use of conventional momentum management systems or propulsion systems. By carefully selecting the physical structure and mass distribution of the spacecraft, the spacecraft attitude required to achieve torque balancing can be selected such that appliances, such as antennas, solar panels, and instruments, will have the required orientation. At least in part, such design contemplates selecting the distribution of mass such that gravity gradient effects, in combination with other external torques and cross-coupling inertial effects, produce the desired spacecraft attitude.

The spacecraft torque balancing systems and methods described above can be used advantageously to maintain a spacecraft in a desired orientation, within given error bounds. When used in combination with a conventional momentum management system, the torque balancing system described can significantly alleviate the load placed on the conventional momentum management system. In addition, the torque balancing described above may greatly reduce the need to operate propulsion devices, and could render a conventional momentum management system unnecessary. This can advantageously extend the life of a spacecraft, by allowing limited supplies of consumable propellants or fuels needed for periodic momentum unloading to last longer, or to allow a spacecraft to continue to function after it has exhausted its supply of consumable propellants or fuels or if its conventional momentum management system has failed.

Although this invention has been described as it could be applied to a spacecraft in orbit, these are merely examples of ways in which the invention may be applied. The invention is not limited to these examples, and could be applied to many other environments.

The embodiments described herein are exemplary. Thus it will be appreciated that although the embodiments are described in terms of specific technologies, other equivalent technologies could be used to implement systems in keeping with the spirit of the present invention.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An attitude controller for a spacecraft comprising:
an attitude determination component providing a signal representing attitude of the spacecraft;
an orbit reference frame determination component providing a signal representing attitude of an orbit reference frame associated with the spacecraft;
a comparison component operatively coupled to the attitude determination component and the orbit reference frame determination component, and responsive to the spacecraft attitude signal and the orbit reference frame attitude signal for determining a signal representing rate of change of a difference between at least one parameter derived from the attitude of the spacecraft and at least one parameter derived from the attitude of the orbit reference frame;
and a momentum management and propulsion control unit responsive to the comparison component to adjust orientation of said spacecraft until the signal representing rate of change is minimized.

2. The attitude controller of claim 1 further comprising a component adapted to establish initial spacecraft attitude and angular rate parameters, wherein said comparison component is responsive to said initial spacecraft attitude and angular rate parameters to instruct the spacecraft attitude control system to orient the spacecraft so as to minimize said rate of signal representing rate of change.

3. The attitude controller of claim 1 wherein the spacecraft experiences external torques, and said attitude controller balances said external torques to minimize said signal representing rate of change.

4. The attitude controller of claim 3 wherein said external torques include torques caused by gravity gradient, and said attitude controller balances said external torques including those caused by gravity gradient to minimize said signal representing rate of change.

5. The attitude controller of claim 1 wherein:
said spacecraft rotates about a first axis at a first angular rate;
said spacecraft orbits around a second axis at a second angular rate;
said spacecraft experiences orbital disturbances;
said spacecraft experiences cross coupling inertial effect resulting from said rotation and said orbit; and
said controller balances said external torques, said orbital disturbances, and said cross coupling inertial affect to minimize said signal representing rate of change.

6. The attitude controller of claim 6 wherein said spacecraft rotates about a third axis at a third angular rate.

7. The attitude controller of claim 1 wherein said signal representing rate of change represents angular acceleration.

8. The attitude controller of claim 1 further comprising a component for establishing an acceptable range of variations in attitude of said spacecraft corresponding to variations correctable through torque balancing.

9. The attitude controller of claim 8 adapted to inhibit operation of said momentum management and propulsion control unit when variation in attitude of said spacecraft is determined to lie within said acceptable range.

10. The attitude controller of claim 8 further comprising a component operative to establish a target angular position and angular rate of said spacecraft responsive to predicted disturbance torques, and to revise said target angular position and angular rate responsive to determining that actual disturbance torques experienced by the spacecraft differ from the predicted disturbance torques.

11. A method of controlling spacecraft attitude comprising the steps of:
a. selecting target spacecraft attitude angles and angular rates so that predicted orbital disturbances and predicted cross-coupling inertial effects experienced by the spacecraft are balanced by predicted external torques experienced by the spacecraft;
b. measuring the rate of change of the difference between a first set of parameters derived from angular position and rate of the spacecraft and a second set of parameters derived from angular position and rate of an associated orbit reference frame; and
c. responsive to the measured rate of change of the difference between said first set of parameters and said second set of parameters, adjusting the spacecraft orientation such that the rate of change of the difference between said parameters is reduced to minimize the angular accelerations experienced by the spacecraft.

12. The method of claim 11, further comprising the step of:
d. repeating step c. until the rate of change of the difference between said first set of parameters and said second set of parameters is minimized.

13. The method of claim 11, further comprising the step of determining orbital characteristics of the spacecraft, and responsive thereto, predicting approximate external torques to which said spacecraft will be subject on an orbit of said characteristics.

14. The method of claim 13, further comprising the step of, responsive to the determined orbital characteristics of the spacecraft, predicting orbital disturbances and cross-coupling inertial effects to which said spacecraft will be subject on an orbit of said characteristics.

15. The method of claim 11 further comprising establishing an acceptable range of variations in attitude of said spacecraft corresponding to variations correctable through torque balancing.

16. The method of claim 15 further comprising inhibiting operation of said momentum management and propulsion control unit when variation in attitude of said spacecraft is determined to lie within said acceptable range.

17. The method of claim 11 further comprising measuring orbital disturbances, cross coupling inertial effects and external torques experienced by the spacecraft.

18. The method of claim 17 further comprising revising said target spacecraft attitude angles and angular rates responsive to said measured orbital disturbances, cross coupling inertial effects, and external torques experienced by the spacecraft, such that said measured orbital disturbances, cross coupling inertial effects and external torques experienced by the spacecraft are balanced.

19. A method of constructing a spacecraft comprising the steps of:
determining expected orbital characteristics of the spacecraft;
predicting approximate external forces and orbital disturbances expected to affect said spacecraft on an orbit of the determined characteristics; and
constructing the spacecraft with a distribution and orientation of mass selected such that when said spacecraft travels on an orbit of the determined characteristics, the sum of net external torques, orbital disturbances, and any cross-coupled inertia effects experienced by said spacecraft is approximately zero.

20. The method of claim 19 further comprising:
establishing in a control system of said spacecraft target attitude angles and angular rates so that orbital disturbances and cross-coupling inertial effects experienced by the spacecraft are balanced by external torques experienced by the spacecraft, once said spacecraft is deployed.
